(19) United States
(12) Patent Application Publication
(10) Pub. No.: US 2011/0016795 A1
(43) Pub. Date: Jan. 27, 2011

(54) CARRIER SUPPORTED PULL-CUP

(76) Inventors: Brian H. Staser, Oxford, MI (US); Christopher L. Faille, New Lothrop, MI (US)

Correspondence Address: CANTOR COLBURN LLP, 20 Church Street, 22nd Floor, Hartford, CT, 06103, US

(21) Appl. No.: 12/783,332

(22) Filed: May 19, 2010

Related U.S. Application Data
(60) Provisional application No. 61/179,522, filed on May 19, 2009.

(51) Int. Cl. E05B 1/00; F16M 13/02

(52) U.S. Cl. 49/460; 248/220.21

(57) ABSTRACT

A door bracket for a window lift assembly is provided, the bracket having: a bottom mount and support portion; and a lateral mount and lateral support portion, the lateral mount and lateral support portion defining an opening for receipt of a pull cup therein.

### CROSS REFERENCE TO RELATED APPLICATIONS

This application claims the benefit of U.S. Provisional Patent Application Ser. No. 61/179,522 filed May 19, 2009 the contents of which are incorporated herein by reference thereto.

### BACKGROUND

Exemplary embodiments of the present invention relate to a feature for assisting in the closing of a vehicle door.

There are various designs of trim features to assist the driver or passenger of a car in closing a door. These features generally consist of pull grips and pull cups. Pull cups are traditionally either an integral part of a door trim assembly or a separate cup loaded to the door after the door trim panel is installed. The cup is traditionally secured to the door with one or two threaded fasteners through the bottom of the cup into a steel trim bracket either formed in the door inner panel or attached to the door inner panel or door hardware module.

An attachment of this form uses the trim bracket to hold the bottom of the cup, but a majority of the lateral loads applied to the cup in closing the door are transferred into the armrest of the trim panel, thus the trim panel must be reinforced to carry the loads. This adds to cost and complexity of the vehicle trim panel.

Accordingly, it is desirable to provide a pull cup without a reinforced trim panel.

### SUMMARY OF THE INVENTION

In accordance with an exemplary embodiment of the invention, a door bracket for a window lift assembly is provided, the bracket having: a bottom mount and support portion; and a lateral mount and lateral support portion, the lateral mount and lateral support portion defining an opening for receipt of a pull cup therein.

In another exemplary embodiment an assembly of a door bracket, a window lift assembly and a pull cup is provided the assembly having: a window lift assembly; a pull cup; a door bracket having a bottom mount and support portion integrally molded with a lateral mount and lateral support portion, the lateral mount and lateral support portion having a pair of opposing side walls and a pair of opposing lateral support wall portions, wherein each of the pair of opposing side walls is connected to each of the pair of opposing lateral support wall portions and the door bracket further comprises a pair of structural arm members each extending from at least one of the pair of opposing side wall portions and wherein each of the structural arm members is configured to have a mounting portion with a mounting surface configured to receive and engage a guide rail of the window lift assembly and the pair of opposing side walls and pair of opposing lateral support wall portions defining an opening for receipt of the therein.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIG. 1 illustrates a bracket for a bottom mounted pull cup;

FIG. 2 illustrates an inboard view of a bracket design in accordance with an exemplary embodiment of the present invention;

FIG. 3 illustrates an inboard view of a bracket design with a pull cup inserted therein; and

FIGS. 4 and 5 illustrate the bracket secured to a vehicle door.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

Exemplary embodiments of the present invention relate to an apparatus and method for providing a pull cup for a vehicle door. In one embodiment, the present invention eliminates the need for reinforcing the trim panel of a vehicle.

One non limiting embodiment of the present invention relates to providing a bracket design that not only secures the bottom of the cup so that it cannot be pulled up out of the trim, but also provides lateral support to the top in a manner that the trim bracket carries all of the door closing loads, and thus the trim does not need to be reinforced.

FIGS. 2-4 illustrate one such device in accordance with an embodiment of the present invention. Reference is also made to U.S. Patent Publication Nos. US20080222962 filed Sep. 18, 2008; and U.S. Patent Publication US20100024306 filed Jul. 31, 2009, the contents each of which are incorporated herein by reference thereto.

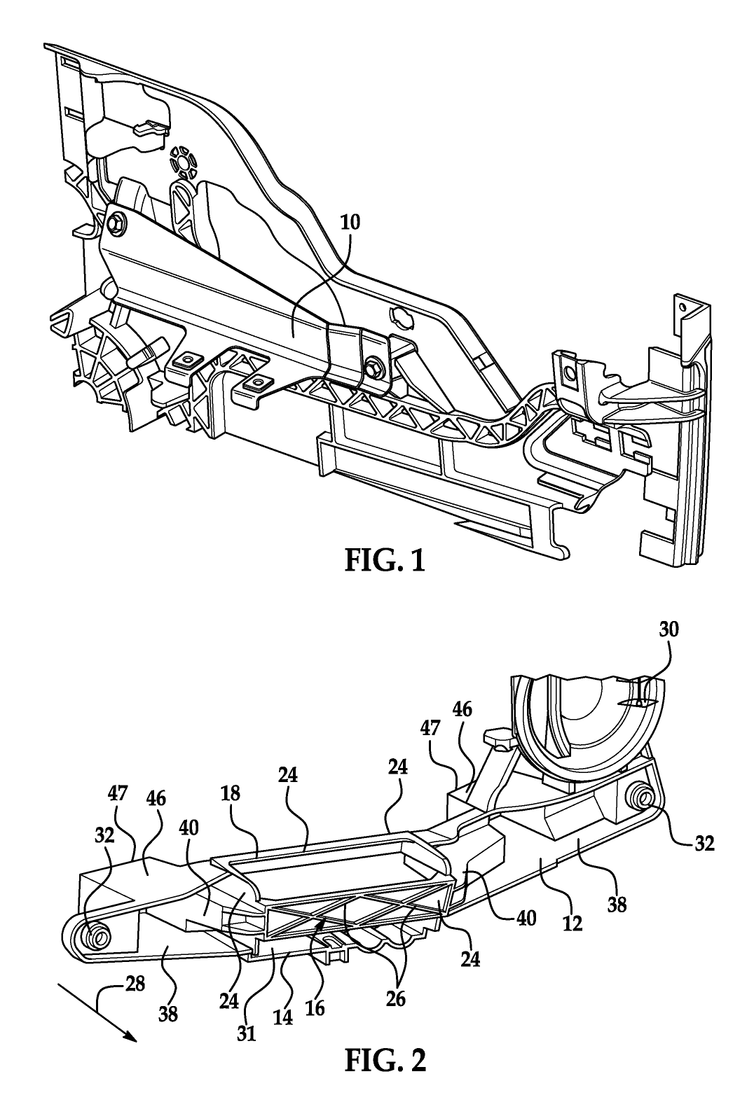

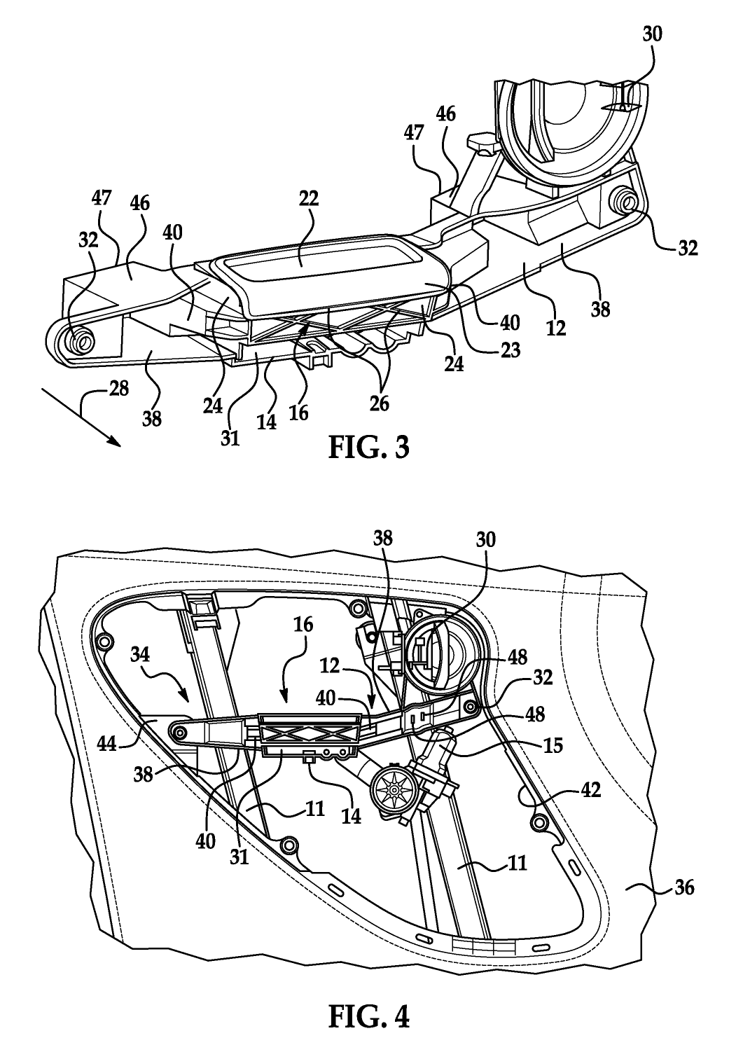

FIG. 1 illustrates a bracket 10 for a bottom mounted pull cup while FIGS. 2-5 illustrate a bracket 12 in accordance with an exemplary embodiment of the present invention. As illustrated in at least FIGS. 2 and 3 the bracket 12 is intended for use with a window lift system and bracket 12 is a component of the window lift system wherein guide rails 11 are movably mounted to the bracket for securement of the entire assembly to the vehicle door. As illustrated, the bracket has a bottom mount and support portion 14 and a lateral mount and lateral support portion 16 wherein the lateral mount and lateral support portion 16 comprises a plurality of walls or wall portions that define an opening 18 for receipt of a pull cup 20 therein. Pull cup 20 defines an opening 22 for receipt of a vehicle occupant's hand therein to pull a door closed. Also illustrated is that the pull cup will have a peripheral edge portion 23 that extends over the lateral mount and lateral support portion and the pull cup defines an interior show surface of a vehicle the door is secured to. In one embodiment, a bottom surface of the pull cup is secured to the bottom mount and support portion by any suitable attachment method and the lateral mount and lateral support portion provides support for lateral loads applied to the pull cup.

As illustrated in at least FIGS. 2 and 3, the lateral mount and lateral support portion 16 has integrally molded wall portions 24, at least some of which contain structural ribs 26. In one non-limiting embodiment, there are two side wall portions and a pair of lateral support wall portions one which defines an inboard side of the lateral support portion and the other one defines an outboard side of the lateral support portion.

In one exemplary embodiment, the bracket is formed from an easily molded material such as plastic or equivalents thereof Furthermore, structural reinforcement can be provided by glass filled plastics or equivalents thereof Of course, other equivalent materials are contemplated to be within the scope of exemplary embodiments of the present invention. As shown in at least FIGS. 2 and 3, the lateral mount and lateral support portion 16 will provide structural reinforcement to forces applied in the direction of arrow 28. In another exemplary embodiment, the bracket is also configured to have an inner door handle 30 mounted thereto. The door handle being coupled to a vehicle door latch for operation of the same in order to open the vehicle door.

In one configuration, the lateral mount and lateral support portion is defined by a pair of opposing side walls and a pair of opposing lateral support wall portions, wherein each of the pair of opposing side walls is connected to each of the pair of opposing lateral support wall portions. Still further and in one embodiment the pair of opposing lateral support wall portions are spaced from and located above the bottom mount and support portion such that an opening 31 is located therebetween. Opening 31 will minimize the amount of plastic required for molding purposes without compromising the structural integrity of the bracket.

Bracket 12 further comprises a plurality of mount openings 32 for securement of the bracket and ultimately the entire window lift system 34 to a vehicle door inner 36. In one non-limiting exemplary embodiment, the mount openings are positioned in one of a pair of structural arm members 38 each of which extends from at least one of the pair of side wall portions 24. In addition and in one embodiment, the structural arm members are integrally molded with the side wall portion and extend therefrom. Moreover and as illustrated, a structural feature 40 is molded at the interface of the structural arm member and the side wall portion. Still further and in another embodiment, the vehicle door handle 30 is mounted to one of the structural arm members extending from the side wall portion of the lateral support portion.

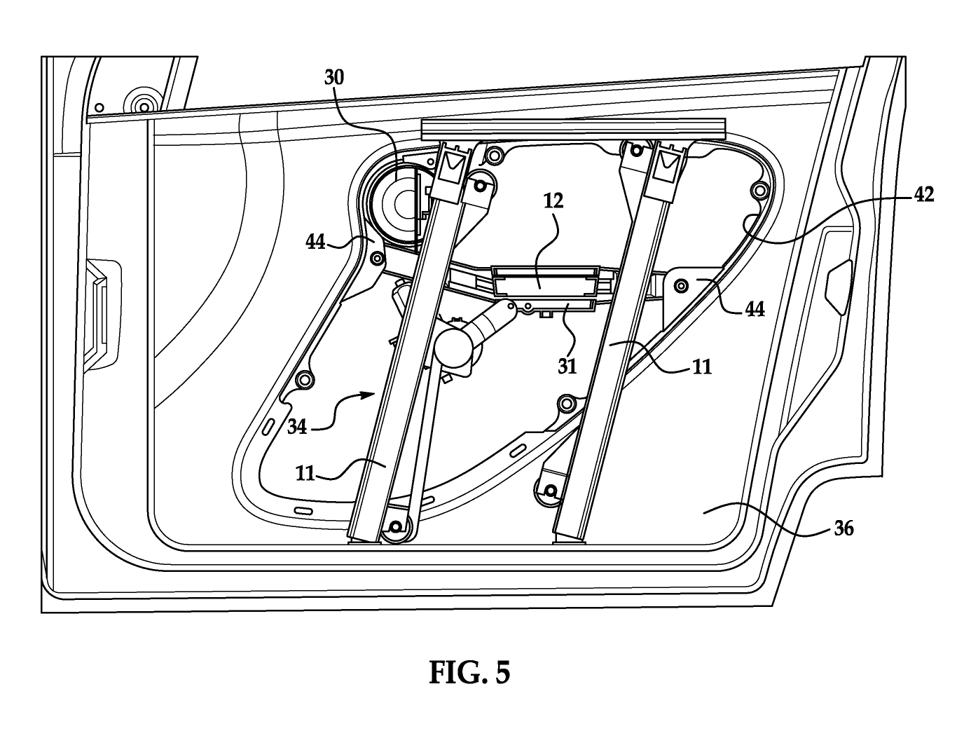

As illustrated and in one embodiment, the mount openings 32 are located proximate to distal ends of the structural arm members. In addition and as illustrated in at least FIGS. 4 and 5 and in one non-limiting embodiment, the bracket is mounted to a peripheral portion of an opening 42 of the vehicle door inner. In one implementation, the vehicle door inner is configured to have tab members or ears 44 extending into the opening 42 in order to provide a securement surface for the distal ends of the structural arm members.

Also illustrated in the FIGS. is that the window lift system 34 is secured to the bracket and the bracket provides a simple and efficient means for securing the window lift system to the vehicle door inner. For example and in one embodiment, the structural arm members are each configured to have a mounting portion 46 providing a mounting surface 47 configured to receive and engage a guide rail 11 of the window lift assembly. In one implementation, the guide rail and/or the feature will be configured with engagement features or tabs 48 which can secure the guide rail to the structural arm member in an interlocking or friction fit. In addition and in one embodiment, feature 48 will be configured to provide a limited amount of movement of the guide rail with respect to the bracket so the guide rail can be located or datumed to the door inner and such limited movement allows for variances or door inner manufacturing tolerances. Of course, numerous other equivalent securement methods are contemplated. Non-limiting examples include; screws, rivets, bolts, welds, adhesives and equivalents thereof

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A door bracket for a window lift assembly, the bracket comprising:
a bottom mount and support portion;
a lateral mount and lateral support portion, the lateral mount and lateral support portion defining an opening for receipt of a pull cup therein.

2. The door bracket as in claim 1, wherein the lateral mount and lateral support portion is defined by a pair of opposing side walls and a pair of opposing lateral support wall portions, wherein each of the pair of opposing side walls is connected to each of the pair of opposing lateral support wall portions.

3. The door bracket as in claim 2, wherein at least one of the pair of opposing lateral support wall portions is configured to each structural ribs.

4. The door bracket as in claim 3, wherein the door bracket is molded from structurally reinforced plastic.

5. The door bracket as in claim 1, wherein the lateral mount and lateral support portion is defined by a pair of opposing side walls and a pair of opposing lateral support wall portions, wherein each of the pair of opposing side walls is connected to each of the pair of opposing lateral support wall portions and the door bracket further comprises a pair of structural arm members each extending from at least one of the pair of opposing side wall portions.

6. The door bracket as in claim 5, wherein a vehicle door handle is mounted to one of the pair of structural arm members extending from the side wall portion of the lateral support portion.

7. The door bracket as in claim 5, further comprising a structural feature molded at the interface of the pair of opposing side walls and the pair of structural arm members.

8. The door bracket as in claim 5, wherein the pair of structural arm members have mount openings formed at a distal end of the pair of structural arm members.

9. The door bracket as in claim 8, wherein the door bracket provides a means for mounting a window lift system to a vehicle door inner.

10. The door bracket as in claim 8, wherein the pull cup defines an opening that is located within the opening of the lateral mount and lateral support portion.

11. The door bracket as in claim 8, further comprising a structural feature molded at the interface of the pair of opposing side walls and the pair of structural arm members.

12. The door bracket as in claim 1, wherein the lateral mount and lateral support portion is defined by a pair of opposing side walls and a pair of opposing lateral support wall portions, wherein each of the pair of opposing side walls is connected to each of the pair of opposing lateral support wall portions and wherein the pair of opposing lateral support wall portions are spaced from and located above the bottom mount and support portion such that an opening is located therebetween.

13. The door bracket as in claim 1, wherein the pull cup defines an opening that is located within the opening of the lateral mount and lateral support portion.

14. The door bracket as in claim 1, wherein the lateral mount and lateral support portion is defined by a pair of opposing side walls and a pair of opposing lateral support wall portions, wherein each of the pair of opposing side walls is connected to each of the pair of opposing lateral support wall portions and one of the pair of lateral support wall portions defines an inboard side of the lateral support portion and the other one defines an outboard side of the lateral support portion.

15. The door bracket as in claim 14, wherein the pair of opposing lateral support wall portions are spaced from and located above the bottom mount and support portion such that an opening is located therebetween.

16. The door bracket as in claim 15, wherein the door bracket provides a means for mounting a window lift system to a vehicle door inner.

17. The door bracket as in claim 1, wherein the lateral mount and lateral support portion is defined by a pair of opposing side walls and a pair of opposing lateral support wall portions, wherein each of the pair of opposing side walls is connected to each of the pair of opposing lateral support wall portions and the door bracket further comprises a pair of structural arm members each extending from at least one of the pair of opposing side wall portions and wherein each of the structural arm members is configured to have a mounting portion with a mounting surface configured to receive and engage a guide rail of the window lift assembly.

18. The door bracket as in claim 17, wherein the door bracket provides a means for mounting a window lift system to a vehicle door inner.

19. In combination, a door bracket for a window lift assembly and a pull cup secured to the door bracket, the combination comprising:
a window lift assembly;
a pull cup;
a door bracket having a bottom mount and support portion integrally molded with a lateral mount and lateral support portion, the lateral mount and lateral support portion having a pair of opposing side walls and a pair of opposing lateral support wall portions, wherein each of the pair of opposing side walls is connected to each of the pair of opposing lateral support wall portions and the door bracket further comprises a pair of structural arm members each extending from at least one of the pair of opposing side wall portions and wherein each of the structural arm members is configured to have a mounting portion with a mounting surface configured to receive and engage a guide rail of the window lift assembly and the pair of opposing side walls and pair of opposing lateral support wall portions defining an opening for receipt of the therein.

20. The combination as in claim 19, wherein the door bracket provides a means for mounting a window lift system to a vehicle door inner, wherein the vehicle door inner has tab members or ears extending into an opening of the vehicle door inner in order to provide a securement surface for distal ends of the structural arm members.
